(19) United States
(12) Patent Application Publication
(10) Pub. No.: US 2007/0159806 A1
(43) Pub. Date: Jul. 12, 2007

(54) Light-guide plate, area light source apparatus, and image reading apparatus

(76) Inventors: Kouzou Fujino, Osaka (JP); Makoto Ikeda, Osaka (JP); Tomihisa Saitou, Osaka (JP)

Correspondence Address: RATNERPRESTIA, P O BOX 980, VALLEY FORGE, PA, 19482-0980, US

(21) Appl. No.: 11/717,362

(22) Filed: Mar. 13, 2007

Related U.S. Application Data
(62) Division of application No. 10/081,968, filed on Feb. 21, 2002.

(30) Foreign Application Priority Data
Feb. 21, 2001 (JP) 2001-44.750
Feb. 26, 2001 (JP) 2001-49.630
Apr. 24, 2001 (JP) 2001-125.395
Dec. 25, 2001 (JP) 2001-391.549

(51) Int. Cl. G09F 13/04

(52) U.S. Cl. 362/97

(57) ABSTRACT

An LED module is mounted on a case frame by fitting three pins formed at a concave portion of the case frame, into holes in the LED module corresponding to the pins. A light-guide plate is fitted into the case frame formed integrally with a bottom cover in a descending direction. The light-guide plate is fixed by a hook provided for the case frame. A space between the light-guide plate and the LED module is prevented by pressing the light-guide plate to the LED module with a pressing spring. Since the light-guide plate is fitted into the case frame in the descending direction and a light scattering sheet is adhered to an outer end surface of the case frame in the descending direction, it is not necessary to reverse the worked product and so the number and time of working processes can be saved.

### BACKGROUND OF THE INVENTION

1. Field of the Invention

The present invention relates to a area light source apparatus using an LED (Light Emitting Diode) and a light-guide plate, and an image reading apparatus using the area light source apparatus.

2. Description of the Related Art

In recent years, a area light source apparatus using an LED and a light-guide plate has been manufactured. The area light source apparatus has been used as a light transmitting unit in a CIS (Contact Image Sensor)-type image scanner, etc.

FIG. 1 is a diagram showing the appearance of a light-guide plate used for a conventional area light source apparatus. Referring to FIG. 1, a light-guide plate 40 is planar- and rectangular-shaped. A light-guide plate 40 uses transparent materials such as acrylic materials and glass. An LED module as a light source is arranged on a side surface of the light-guide plate 40. A light scatterer (printing dot) pattern is formed on a rear surface of the light-guide plate 40 so that light outputted from the LED module has a uniform scattered-light distribution on a front surface of the light-guide plate 40.

FIG. 2 is a diagram for explaining the propagation of the light, which is inputted to the light-guide plate 40 from the LED module, in the light-guide plate 40. Referring to FIG. 2, the light inputted to the light-guide plate 40 from the LED module travels in the light-guide plate 40 while repeating the total reflection, and is scattered with a light scatterer pattern 46. A part of the scattered light is outputted from a light-emitting surface of the light-guide plate 40 and, further, a part of the outputted scattered-light is leaked out on the rear surface (an opposite side of the light-emitting surface) and on the side surface of the light-guide plate 40. The light outputted from the light-emitting surface is scattered with a light scattering sheet 47. The light leaked from the rear surface of the light-guide plate 40 is re-inputted to the light-guide plate 40 with a white reflecting base material 48.

FIG. 3 is an exploded perspective view of the conventional area light source apparatus. Referring to FIG. 3, the area light source apparatus comprises the transparent light-guide plate 40, an LED module 49, a case frame 50, the light scattering sheet 47, and a bottom plate 45.

The LED module 49 is adhered to opposed inner surfaces in a direction perpendicular to a longitudinal direction of the case frame 50. Both-end surfaces in a direction perpendicular to a longitudinal direction of the bottom plate 45 have a notch for pulling out a lead of the LED module 49. A light scatterer pattern for scattering the light inputted to the light-guide plate 40 from the LED module 49 is formed on the rear surface of the light-guide plate 40.

The conventional area light source apparatus is assembled as follows. First, the LED module 49 is adhered to an inner surface of the case frame 50 with an adhesive. Next, the light-guide plate 40 is fitted into the case frame 50, to which the LED module 49 is adhered, in an ascending direction. Further, the light-guide plate 40 is pressed with the bottom plate 45 and, finally, the light scattering sheet 47 is adhered to an upper-end surface of the case frame 50.

Compact size of the aforementioned CIS-type image scanner is required because of the demand of the saved space. Advantageously, thinner area light source apparatus enables the compact size thereof. A thinner area light source apparatus (thickness of the conventional one: 5 mm) requires a thinner light-guide plate (thickness of the conventional one: 3.5 mm). However, the thinner light-guide plate causes a problem in that the light is concentrated at an edge (side) portion and a corner portion of the light-guide plate 40 and strong scattered-light is generated from the edge portion and the corner portion. Further, a scratch and defects due to die molding are easily caused near the edge portion and the corner portion. The scratch and the defects due to the die molding cause a problem in that unnecessary scattered light having an emission line is generated.

FIG. 4 is an enlarged view of the edge portion and the corner portion of the conventional light-guide plate used for the area light source apparatus, in which a diagonal line represents a sectional shape. Referring to FIG. 4, the conventional light-guide plate 40 has the edge portion and the corner portion with a right angle.

If a thickness d of the light-guide plate 40 having the edge portion and the corner portion with the right angle is made thin, the intensity of light which propagates in the light-guide plate 40 while it is multi-reflected, is increased by a reduced volume of the light-guide plate 40.

Hence, the keeping of the scattered-light distribution of the light-guide plate 40 at the same level before the light-guide plate 40 is made thin, requires the reduction of an area of the light scatterer (printing dot) patterns, formed on the rear surface of the light-guide plate 40, in proportional to the reduced volume of the light-guide plate 40. The reduction of the area causes the edge portion and the corner portion, a fine scratch (uneven portion) on the surface, etc. of the light-guide plate 40 to be a relatively large scattering source, thus emitting strong scattered light.

Next, the scratch on the conventional light-guide plate will be explained. FIG. 5 is a diagram showing the scratch caused on the edge portion and the corner portion of the light-guide plate. In general, the light-guide plate 40 is formed by injection molding, and a scratch 41 is caused by pulling out the light-guide plate 40 from a die. It is well-known that the scratch 41 produces the strong scattered light.

The die for molding the light-guide plate 40 is concave-shaped. Therefore, it is difficult to smoothly work the die including an end part of the edge portion with the right angle. The scratch due to defective finish or incomplete scouring is formed at the edge part of the die.

A scratch 42 is caused at the edge portion of the light-guide plate 40, which is die-molded, by transferring the scratch due to the defective finish. Further, a scratch 43 is caused at the edge portion of the light-guide plate 40 by transferring the scratch due to the incomplete scouring. These scratches 42 and 43 result in generating the strong scattered light from the edge portion of the light-guide plate 40.

The scratches due to the defective finish and the incomplete scouring are transferred to a corner portion 44 of the light-guide plate 40, resulting in generating the strong scattered light from the corner portion 44 of the light-guide plate 40.

As mentioned above, the thinner light-guide plate makes the scattered light generated from the fine scratch at the edge portion and the corner portion in the light-guide plate 40, relatively strong. Thus, a singular noise-light distribution is added to the scattered-light distribution on the light-guide plate.

Moreover, the thin edge portion and corner portion with the right angle in the light-guide plate need a high temperature and a high pressure to fill up to the edge portion with a material upon die molding. This causes a problem in that the increase in temperature reduces the transparency of the material.

As shown in FIG. 2, the above conventional area light source apparatus has the white reflecting base material for re-inputting the light leaked to the rear surface (the opposite side of the light-emitting surface) and to the side surface of the light-guide plate 40. Advantageously, the white reflecting base material causes a luminance distribution on the light-emitting surface to be more uniform by scattering and reflecting the leaked light. On the other hand, a reflection coefficient of the white reflecting base material is approximately 0.8 smaller than 1. All the amount of incident light is not reflected and a part of the light (0.2 as the remaining) is lost and the luminance is reduced corresponding to the lost light.

The scattering reflecting plate, which is usually used as a reflecting base material, has no mirror surface but finely concave and convex portions on a front surface thereof, which result in light scattering reflection. The scattering reflection is repeated at the concave and convex portions to cause the light multi-reflection. As a consequence, in addition to a reflecting component, an absorption ratio and a transmission ratio of the light to the reflecting plate increase, thus reducing the luminance of the light source.

As described in FIG. 3, since the conventional area light source apparatus is structured by adhering the LED module to the inner surface of the case frame with the adhesive, there is a problem in that it takes a long time to make the adhesive dry and to completely adhere the LED module to the inner surface of the case frame and the number of products is increased during working and before the adhesive is dry.

Furthermore, the working to the case frame from both ascending and descending directions is necessary, more specifically, the light-guide plate and the bottom plate are fitted to the case frame in the ascending direction and the light scattering sheet is adhered to the case frame in the descending direction. Consequently, there is also a problem in that the reverse of a worked product is necessary during the working process, it is troublesome, and the automation is difficult.

### SUMMARY OF THE INVENTION

Accordingly, it is one object of the present invention to provide a light-guide plate whereby unnecessary scattered light is not caused even if it is easily molded and its thickness is made thin, and a area light source apparatus using the light-guide plate.

Also, it is another object of the present invention to provide a area light source apparatus in which the using efficiency of light is increased and the luminance is improved by suppressing, as much as possible, the absorption and the transmission of light with a reflecting base material adhered to a rear surface side and a side surface of a light-guide plate and by re-inputting most part of the light inputted to the reflecting base material to the light-guide plate.

Further, it is another object of the present invention to provide a area light source apparatus capable of saving the time and the number of assembling processes by omitting the reverse of a worked product during a working process, and an image reading apparatus using the area light source apparatus.

According to the present invention, there is provided a area light source apparatus comprising a planar light-guide plate comprising an edge portion and a corner portion which have convexly-curved surfaces.

According to the present invention, the edge portion and the corner portion of the light-guide plate are convexly curved, therefore, the die is easily formed, and the number of scratches of the edge portion in light-guide plate can be reduced. Since the number of scratches of the edge portion in the light-guide plate, to which the die is transferred, can be reduced and the light-guide plate can easily be pull out from the die, the number of scratches which are conventionally caused is reduced and the scattered light due to the scratch can be reduced. The concentration of the light at the edge portion and the corner portion is suppressed and, therefore, the generation of the scattered light from the edge portion and the corner portion can be suppressed. Furthermore, the edge portion and the corner portion of the light-guide plate are convexly curved and, hence, high temperature and high pressures are unnecessary to fill the edge portion with a material upon die molding even if the thickness of the light-guide plate is thin, and the problem in that the increase in temperature reduces the transparency can be solved.

In the present invention, there is provided a area light source apparatus, comprising: a light-guide plate which is planar-shaped; at least one light source which is arranged on a peripheral side-surface of the light-guide plate; a reflecting plate having a high reflectance, which is arranged on a rear-surface side of the light-guide plate and on a side-surface side other than a mounted surface of the light source; a bottom plate which is arranged on a rear-surface side of the reflecting plate; a case frame which is arranged on the side-surface side of the light-guide plate via the reflecting plate; and a light scattering sheet which is arranged on an upper surface of the light-guide plate.

In the present invention, the reflecting plate having the high reflectance is arranged on a rear surface of the light-guide plate or on the rear surface thereof and a side surface, most light outputted from the rear surface of the light-guide plate is returned to the light-guide plate. In other words, since the light can be re-inputted to the light-guide plate, the using efficiency of light of the light source can be increased and, further, the luminance of the area light source apparatus can finally be improved.

Further, in the present invention, there is provided a area light source apparatus comprising: a light-guide plate which is planar-shaped; at least one light source which is arranged on a peripheral side-surface of the light-guide plate; a case frame formed integrally with a bottom cover or separately therefrom, for accommodating the light-guide plate and the light source; and a light scattering sheet which is arranged on an upper surface of the light-guide plate, wherein the light source is arranged on the peripheral side-surface of the light-guide plate by fitting at least one pin formed on the side surface of the light-guide plate, into a hole formed on the light source corresponding to the pin.

In addition, in the present invention, there is provided a area light source apparatus comprising: a light-guide plate which is planar-shaped; at least one light source which is arranged on a peripheral side-surface of the light-guide plate; a case frame formed integrally with a bottom cover or separately therefrom, for accommodating the light-guide plate and the light source; and a light scattering sheet which is arranged on an upper surface of the light-guide plate, wherein the light source is mounted on the case frame by fitting at least one pin formed on the case frame, into a hole formed on the light source corresponding to the pin, and the light-guide plate is fitted into the case frame so that the light source is arranged on the peripheral side-surface of the light-guide plate.

In the present invention, when the light source is mounted on the light-guide plate, an adhering process with an adhesive is not required and it is unnecessary to wait for a time during which the adhesive is dry. Accordingly, a processing time can be reduced and the number of products during working can be decreased. Further, a part is fitted into the case frame from a single direction and, therefore, the reverse of a worked product during a working process is not required, it is troublesome for the working, and the automation of processes is easy.

### BRIEF DESCRIPTION OF THE DRAWINGS

FIG. 1 is a diagram showing the appearance of a light-guide plate used for a conventional area light source apparatus;

FIG. 2 is a diagram for explaining the propagation of the light which is inputted to the light-guide plate from the LED module, in the light-guide plate;

FIG. 3 is an exploded perspective view of the conventional area light source apparatus;

FIG. 4 is an enlarged view of an edge portion and a corner portion of the conventional light-guide plate, which is used for the area light source apparatus;

FIG. 5 is a diagram showing scratches caused at the edge portion and the corner portion of the light-guide plate;

FIG. 6 is an exploded perspective view of a area light source apparatus according to a first embodiment of the present invention;

FIG. 7 is an enlarged view of an edge portion and a corner portion of a light-guide plate shown in FIG. 6;

FIG. 8 is a diagram showing one example of a sectional shape of the light-guide plate;

FIG. 9 is a diagram showing another example of the sectional shape of the light-guide plate;

FIG. 10 is a diagram showing another example of the sectional shape of the light-guide plate;

FIG. 11 is an exploded perspective view of a area light source apparatus according to a second embodiment of the present invention;

FIG. 12 is a diagram showing one example of a light scatterer pattern;

FIG. 13 is an exploded perspective view of the area light source apparatus when a reflecting plate is arranged only at a rear surface of the light-guide plate;

FIG. 14 is a diagram stereoscopically showing a luminance distribution when a high-reflectance film is arranged on the rear surface of the light-guide plate and on a side surface other than a mounted surface of an LED module;

FIG. 15 is a diagram stereoscopically showing a luminance distribution when the high-reflectance film is arranged only on the rear surface of the light-guide plate;

FIG. 16 is a diagram stereoscopically showing a luminance distribution when a case frame and a bottom plate are made of a white high-reflectance material;

FIG. 17 is an exploded perspective view of the area light source apparatus when the reflecting plate is arranged on the rear surface of the light-guide plate and on the side surface other than the LED module;

FIG. 18 is an exploded perspective view of a area light source apparatus according to a third embodiment of the present invention;

FIG. 19A is a perspective view showing one-example of a method for positioning an LED module;

FIG. 19B is a perspective view showing another example of the method for positioning the LED module;

FIG. 20 is an exploded perspective view showing the area light source apparatus according to one modification of the third embodiment;

FIG. 21 is an exploded perspective view showing the area light source apparatus according to another modification of the third embodiment;

FIG. 22 is an exploded perspective view showing the area light source apparatus according to another modification of the third embodiment;

FIG. 23 is an exploded perspective view of a area light source apparatus according to a fourth embodiment of the present invention;

FIG. 24 is a perspective view of a case frame and an enlarged view of one split pin;

FIG. 25 is an exploded perspective view of two LED modules and an enlarged view of the split pin;

FIG. 26 is a diagram showing an example of another split pin;

FIG. 27 is an exploded perspective view showing the area light source apparatus according to one modification of the fourth embodiment;

FIG. 28 is an exploded perspective view showing the area light source apparatus according to another modification of the fourth embodiment;

FIG. 29 is an exploded perspective view showing the area light source apparatus according to another embodiment of the fourth embodiment;

FIG. 30A is a plan view of the case frame showing one example of a formed position of a hook in a plane direction;

FIG. 30B is a plan view of the case frame showing another example of the formed position of the hook in the plane direction;

FIG. 30C is a plan view of the case frame showing another example of the formed position of the hook in the plane direction;

FIG. 31A is a partially cross-sectional view showing one example of a formed position of the hook in a height direction;

FIG. 31B is a partially cross-sectional view showing another example of the formed position of the hook in the height direction;

FIG. 31C is a partially cross-sectional view showing another example of the formed position of the hook in the height direction;

FIG. 31D is a partially cross-sectional view showing another example of the formed position of the hook in the height direction;

FIG. 32 is a diagram showing one example of a light-guide-plate shape;

FIG. 33 is a cross-sectional view when the LED module makes contact with the light-guide plate; and

FIG. 34 is a diagram showing one example of a CIS-type image reading apparatus capable of reading a transparent original.

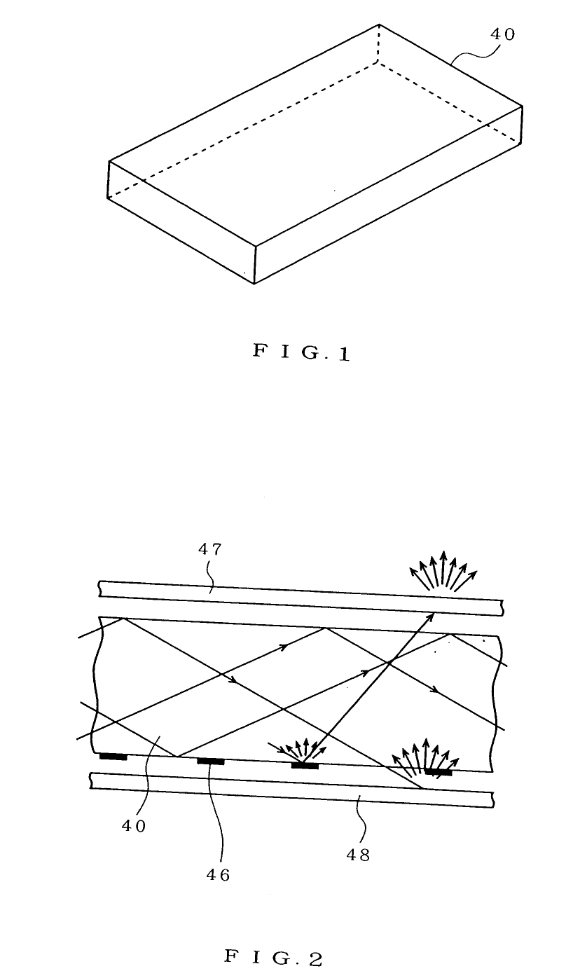

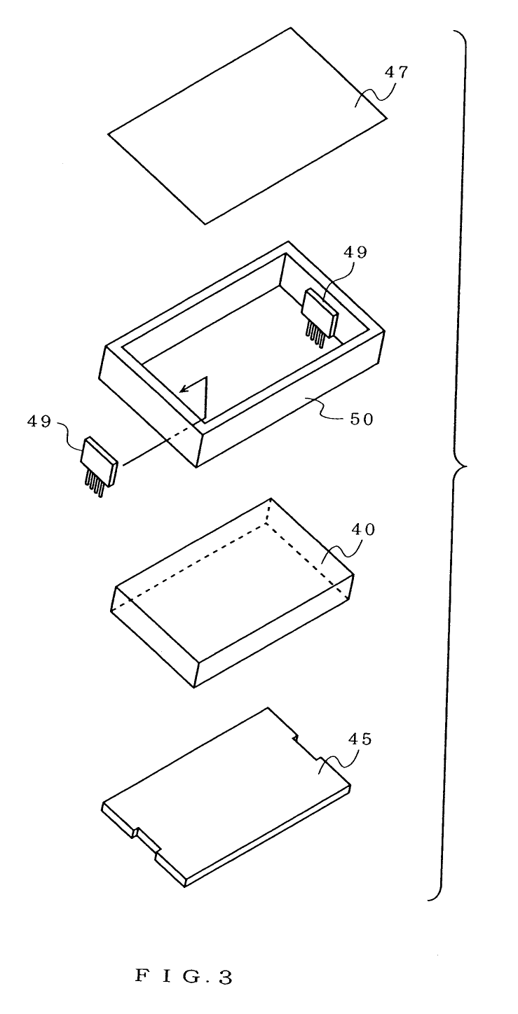

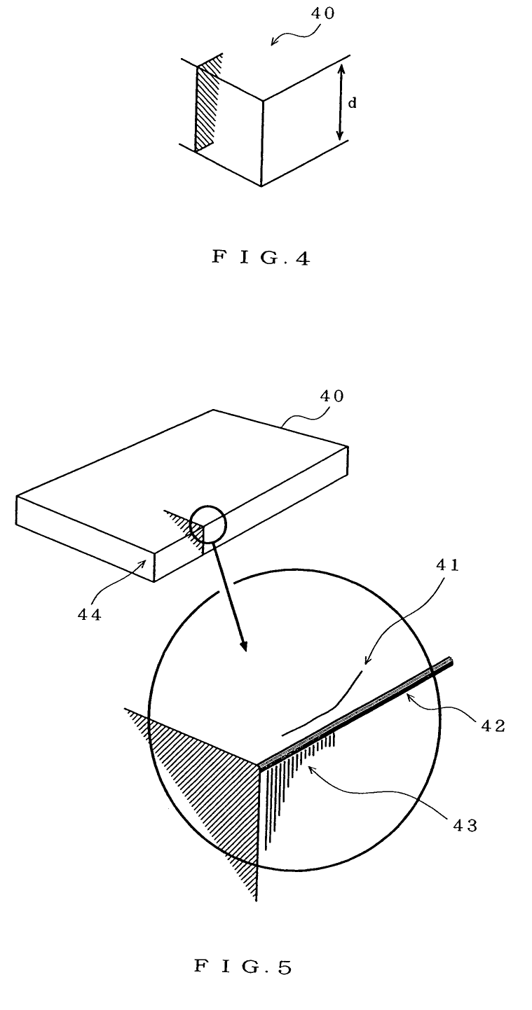

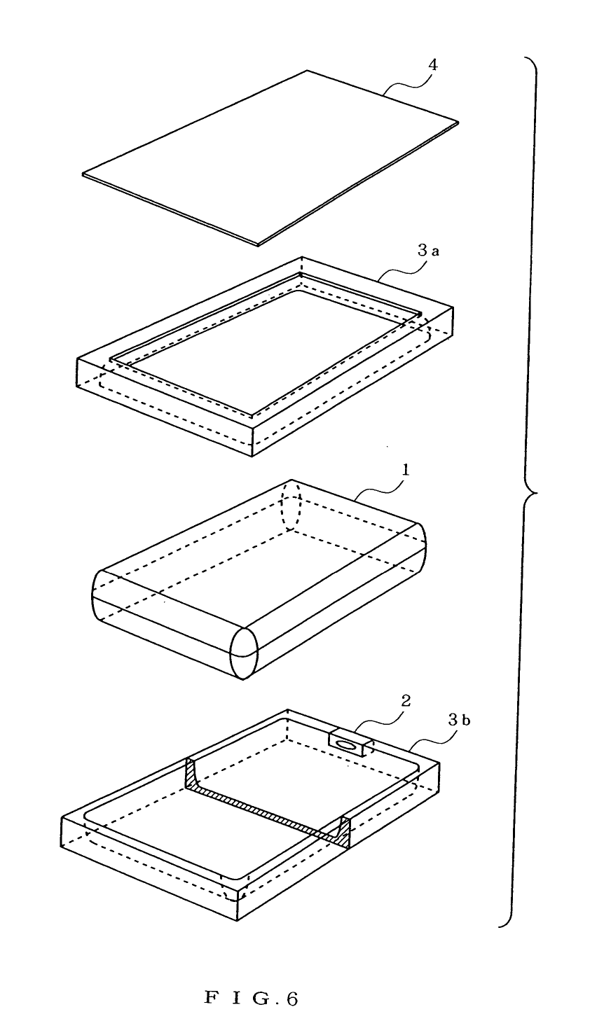

### DESCRIPTION OF THE PREFERRED EMBODIMENTS

Next, embodiments of the present invention will be described hereinbelow with reference to the drawings.

FIG. 6 is an exploded perspective view of a area light source apparatus according to a first embodiment of the present invention. The area light source apparatus shown in FIG. 6 comprises: a light-guide plate 1 which is planar- and rectangular-shaped; case frames 3a and 3b; an LED module 2 as a light source; and a light scattering sheet 4 arranged at an upper surface of the light-guide plate 1.

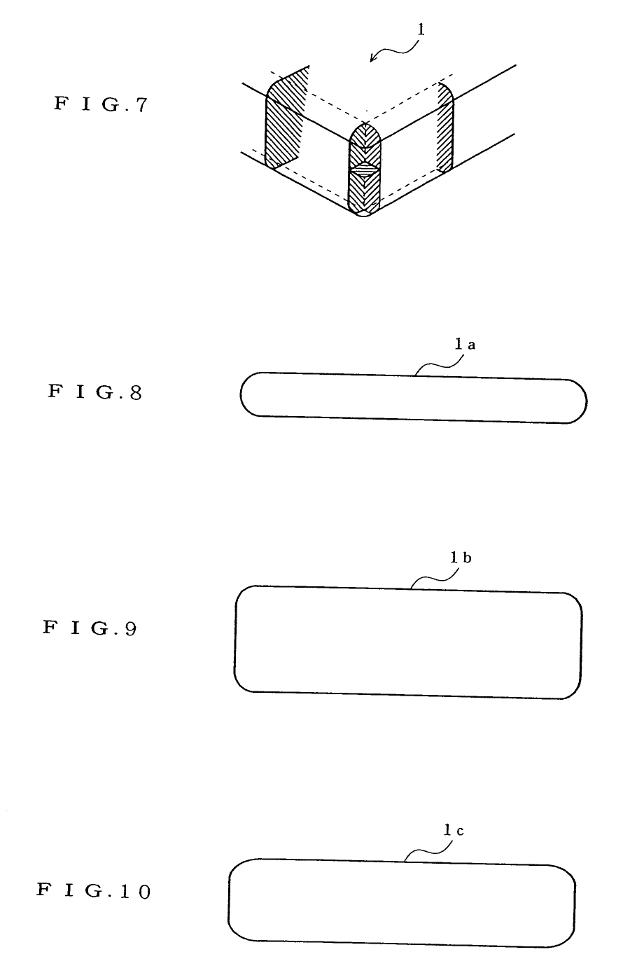

An edge (side) portion and a corner portion of the light-guide plate 1 is convexly shaped. The light-guide plate 1 is made of transparent materials such as an acrylic material and glass. FIG. 7 is an enlarged view of the edge portion and the corner portion of the light-guide plate shown in FIG. 6. A diagonal line represents a sectional shape. Referring to FIG. 7, a side, at which side surfaces of the light-guide plate 1 are made contact, is curve-chamfered. Further, sides, at which an upper surface and a side surface of the light-guide plate 1 are made contact, and sides at which a bottom surface and the side surface thereof are made contact are curve-chamfered.

A light scatterer pattern is formed on the rear surface of the light-guide plate 1 so that light is outputted from an upper surface side (light-emitting surface side) of the light-guide plate 1 at an almost uniform intensity. The light scatterer patterns are formed by a screen printing method using light reflecting white ink with a specific pattern. Usually, a light scatterer is a circular dot but is not limited to a circular shape and may be square-shaped or lozenge-shaped.

A white case frame 3b is arranged on the rear-surface side and a lower side-surface of the light-guide plate 1. A white case frame 3a is arranged at an upper side-surface of the light-guide plate 1. A light scattering sheet 4 is adhered to an upper surface, namely, the light-emitting surface, of the light-guide plate 1. Inner walls of the case frames 3a and 3b are formed along a curve-chamfered surface of the light-guide plate 1.

An LED module 2 as a light source is arranged in the center of an inner surface of the case frame 3b. The LED module 2 is arranged at the case frame 3b so that it make contact with the side surface of the light-guide plate 1 when the area light source apparatus is assembled and light from the LED module 2 is induced to the light-guide plate 1.

The LED module 2 comprises red (R), green (G), and blue (B) LED chips.

The LED module 2 is not limited to the above one but may be arranged at opposed inner surfaces of the case frame 3b or at all the inner surfaces thereof. Further, the LED module 2 is arranged in the center of the inner surface but is limited to this, and may be arranged at any place on the inner surfaces. When the number of LED modules 2 is increased and the position of the LED module 2 is changed, the light scatterer pattern formed on the rear surface of the light-guide plate 1 needs to be changed and be arranged so that the distribution of the scattered light in the light-guide plate 1 becomes uniform.

FIG. 8 is a diagram showing one example of a sectional shape of the light-guide plate, in which a vertical section to a plane direction of the light-guide plate is represented. Referring to FIG. 8, a light-guide plate 1a is curve-chamfered to make the edge portion half-arc-shaped. Both ends of the light-guide plate 1a are half-cylindrical-shaped in respective depth directions (vertical directions of the drawing sheet).

FIG. 9 is a diagram showing another example of the sectional shape of the light-guide plate. Four edge portions of a light-guide plate 1b are curve-chamfered with a ¼ arc, respectively.

FIG. 10 is a diagram showing another example of the sectional shape of the light-guide plate. Referring to FIG. 10, a radius of curvature of the curve chamfer is changed at the edge portion of a light-guide plate 1c.

The light-guide plate may have a half-cylindrical-shaped edge portion which is formed by making the thickness of the light-guide plate thin, as shown in FIG. 8. Alternatively, only the edge portion is curve-chamfered, as shown in FIG. 9. Further, alternatively, the edge portion may be parabolic-shaped or elliptic-shaped, as shown in FIG. 10.

Moreover, the corner portion may be curve-chamfered. Or, the corner portion may be parabolic-shaped or elliptic-shaped.

As mentioned above, since the light-guide plate has the curve-chamfered edge portion and corner portion, an edge (side) of the die whereby the light-guide plate is formed can be curved. Therefore, the edge can smoothly be worked. The number of scratches at the edge portion of the die can be reduced. The light-guide plate which is molded by the above die has the reduced number of scratches at the edge portion, and the scattered light due to the scratch at the edge portion can be reduced.

A corner of the die is curved because of the above similar reason, thereby reducing the number of scratches (uneven portions) at the corner portion. Hence, the scattered light due to the scratch at the corner portion of the light-guide plate can be reduced.

Further, since the edge portion and the corner portion of the light-guide plate are curved, the light-guide plate can easily be pull out from the die. Thus, the number of scratches upon pulling out the light-guide plate is reduced and the scattered light due to the scratch can be decreased.

The thin light-guide plate causes the concentration of the light at the edge portion and the corner portion of the light-guide plate and the generation of strong scattered light from the edge portion and the corner portion of the light-guide plate. However, the curve chamfer of the edge portion and the corner portion in the light-guide plate enables the suppression of the concentration of the light at the edge portion and the corner portion, thus suppressing the generation of the scattered light from the edge portion and the corner portion.

Incidentally, in the first embodiment, the light scatterer is applied onto the rear surface of the light-guide plate by the screen printing method. However, instead of the application of the light scatterer, a method for making the rear surface of the light-guide plate coarse can be employed. Further, methods for making the surface coarse by mechanical working, e.g., a method for forming a numerous number of finely uneven portions using the sandblast method, a method for directly scattering process to the die and transferring it upon molding, or the like can be used.

Although the light-guide plate is planar- and rectangular-shaped in the first embodiment, it is not limited to be rectangular-shaped and may be polygon-shaped or partially be curved.

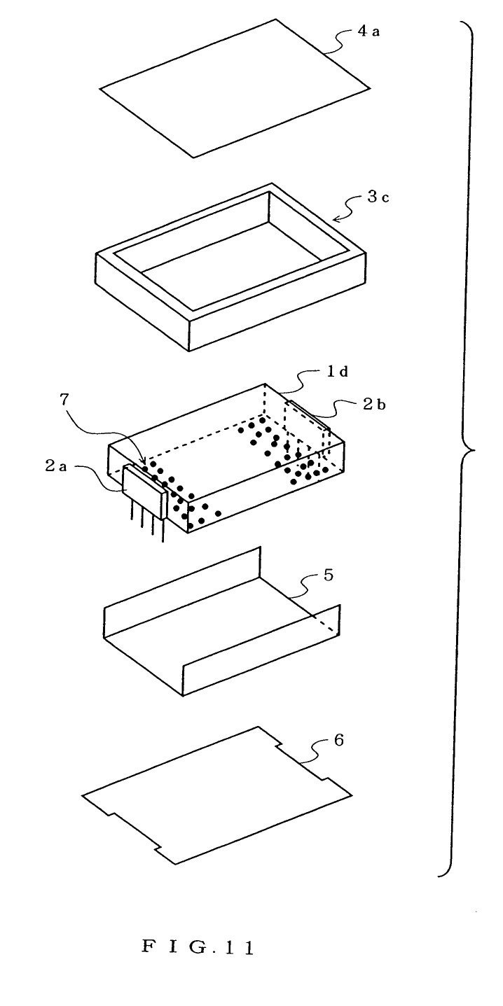

Next, a second embodiment of the present invention will be described. FIG. 11 is an exploded perspective view of a area light source apparatus according to the second embodiment of the present invention.

Referring to FIG. 11, the area light source apparatus comprises a light-guide plate 1d which is planar- and rectangular-shaped, LED modules 2a and 2b as light sources, a reflecting plate 5, a bottom plate 6, a case frame 3c, and a light scattering sheet 4a.

The LED modules 2a and 2b are arranged in the center on opposed side-surfaces in a direction perpendicular to a longitudinal direction of the light-guide plate 1d. The LED modules 2a and 2b comprise red (R), green (G), and blue (B) LED chips.

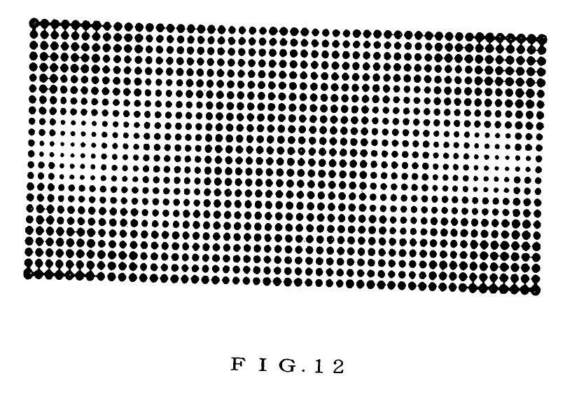

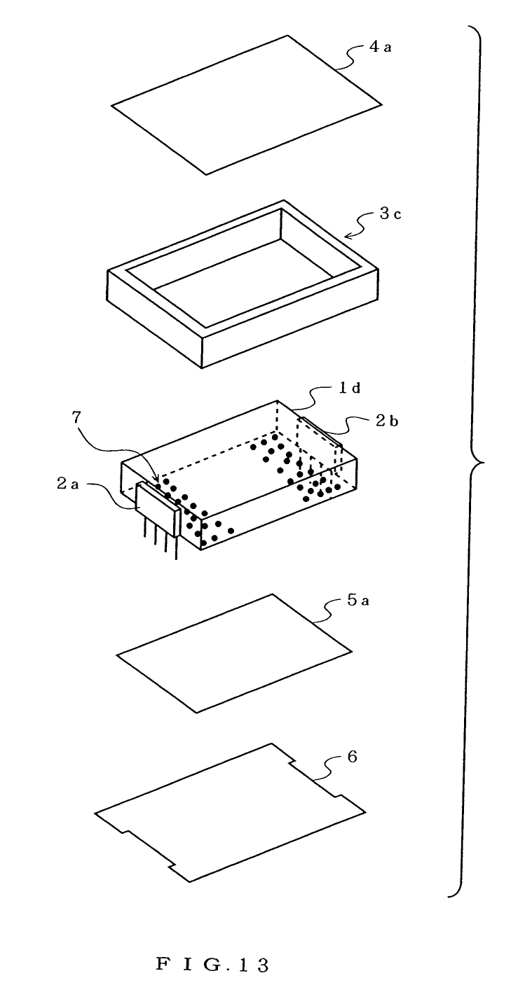

A Light scatterer pattern 7 is formed on a rear surface of the light-guide plate 1d. FIG. 12 is a diagram showing one example of a light scatterer pattern. Black portions represent the light scatterers which have a high reflectance. The reflectance is characterized in that it is minimized at two portions on the surface. In general, the light scatterer is circular-dot-shaped but is not limited to being circular-dot shaped and may be square-shaped or lozenge-shaped.

Further, the reflecting plate 5 having a high reflectance is arranged on a rear surface of the light-guide plate and on a side surface other than mounted surfaces of the LED modules 2a and 2b. The reflecting plate 5 is made of materials having a high reflectance, such as a mirror and an aluminum thin film. Preferably, the reflectance (reflected light/input light) of the reflecting plate 5 is 90% or more, and priorly uses a reflecting base material having a so-called a mirror surface.

The bottom plate 6 is arranged on the rear surface of the reflecting plate 5. Four side surfaces of the light-guide plate 1d are covered with a case frame 3c. The light scattering sheet 4a is adhered to an upper surface of the case frame 3c, namely, a light-emitting surface.

The reflecting plate 5 may be arranged only on the rear surface of the light-guide plate 1d. FIG. 13 is an exploded perspective view of the area light source apparatus when a reflecting plate 5a is arranged only on the rear surface of the light-guide plate.

A comparison experiment is executed by using three cases of actually studying the area light source apparatus. That is, in a first case, a reflecting plate having a high reflectance is arranged on a rear surface of the light-guide plate and at a side surface other than a mounted surface of the LED module. In a second case, the reflecting plate having the high reflectance is arranged only on a rear surface of the light-guide plate. Finally, in a third case, a case frame and a bottom plate are made of a white high-reflectance material without using the reflecting plate having the high reflectance.

The light-guide plate is made of a transparent acrylic material and is rectangular-shaped with finish of a mirror. The light-guide plate is (15.5×8.0×2.0 mm) in size. The reflecting plate having the high reflectance comprises a high-reflectance film using a reflector film produced by TSUJIDEN Co., LTD. having a 98% reflectance. The experiment is performed by arranging the two LED modules on opposed side-surfaces of the light-guide plate. The LED module uses one having a 520 nm peak wavelength, produced by NICHIA CORPORATION. The light scattering sheet of the light-emitting surface uses one of product name D101, produced by TSUJIDEN CO., LTD. The case frame and the bottom plate use a white high-reflectance material which is made of vinyl chloride.

The light scatterer patterns formed on the rear surface of the light-guide plate are formed by the screen printing method using high-reflectance white ink produced by Teikoku Printing inks Mfg. Co., Ltd., with a specific pattern.

Incidentally, the light scatterer pattern uses the same one in the three above cases: in the first case, the high-reflectance film is arranged on the rear surface and the side surface of the light-guide plate; in the second case, the high-reflectance film is arranged only on the rear surface of the light-guide plate; and in the third case, only the white high-reflectance reflecting material is used.

In the above-described area light source apparatus, the LED module is lit on and a distribution of luminances thereof is measured.

A luminance measuring system is assembled by combining a luminance meter BM7 produced by TOPCON CORPORATION, with a measured spot diameter of 0.2 mmΦ, and an XY moving stage produced by OHNO RESEARCH & DEVELOPMENT LABORATORIES CO., LTD. The XY moving stage with a measured subject is moved under the control of a personal computer, thereby scanning a spot of the fixed luminance meter. Then, the measured subject is sampled at specific fine XY pitches to measure the luminance. A moving step of the XY pitch is 0.1 mm at the minimum level, a stroke range thereof is 350 mm in the X-direction and is 250 mm in the Y-direction.

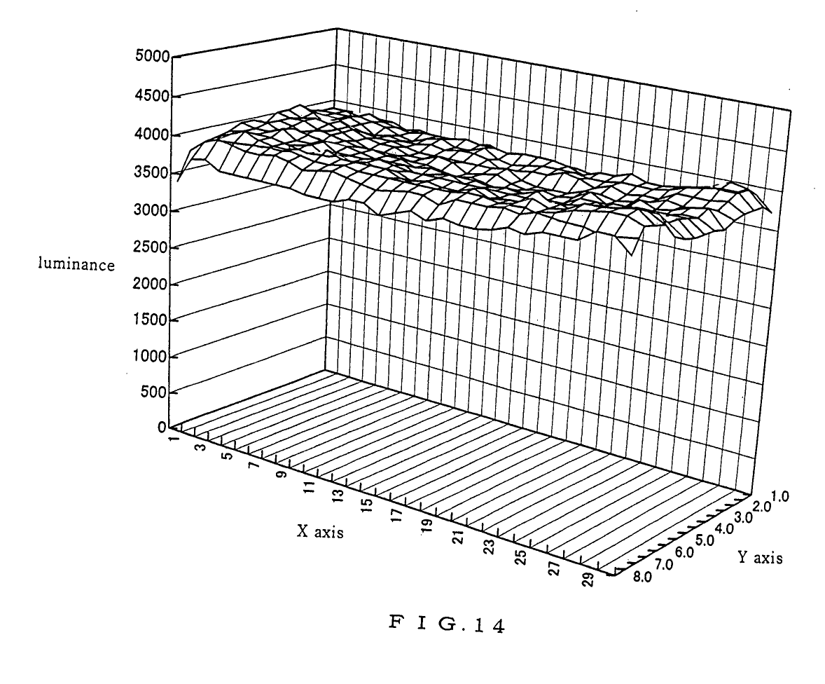

In the case study, the XY pitch for the luminance measurement is 0.5 mm in the X and Y directions. Spots at (30×15) points are measured on the light-emitting surface of (15.5×8.0 mm). Referring to FIGS. 14 to 16, the number of measured points on the X axis is 30 consisting of 1, 2, 3, . . . , 30. The number of measured points on the Y axis is 15 points consisting of 1.0, 1.5, 2.0, . . . , 8.0.

FIG. 14 is a diagram stereoscopically showing a luminance distribution when the high-reflectance film is arranged on the rear surface of the light-guide plate and on a side surface other than a mounted surface of the LED module. The XY coordinate shows the light-emitting surface, one corner of the light-emitting surface is origin on the XY coordinate, the X axis is equally divided into 30 intervals, and the Y axis is equally divided into 15 intervals. Incidentally, the axis perpendicular to the XY coordinate surface is a measured luminance (unit: cd/m²). The average of the measured luminance is 3,875 cd/m².

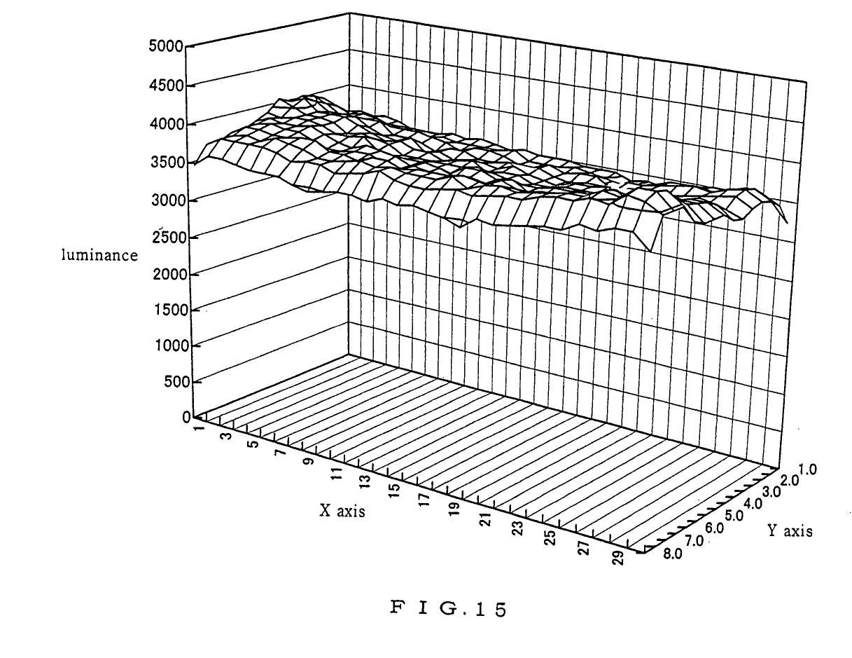

FIG. 15 is a diagram stereoscopically showing the luminance distribution when the high-reflectance film is arranged only on the rear surface of the light-guide plate. The average of the measured luminance is 3,689 cd/m².

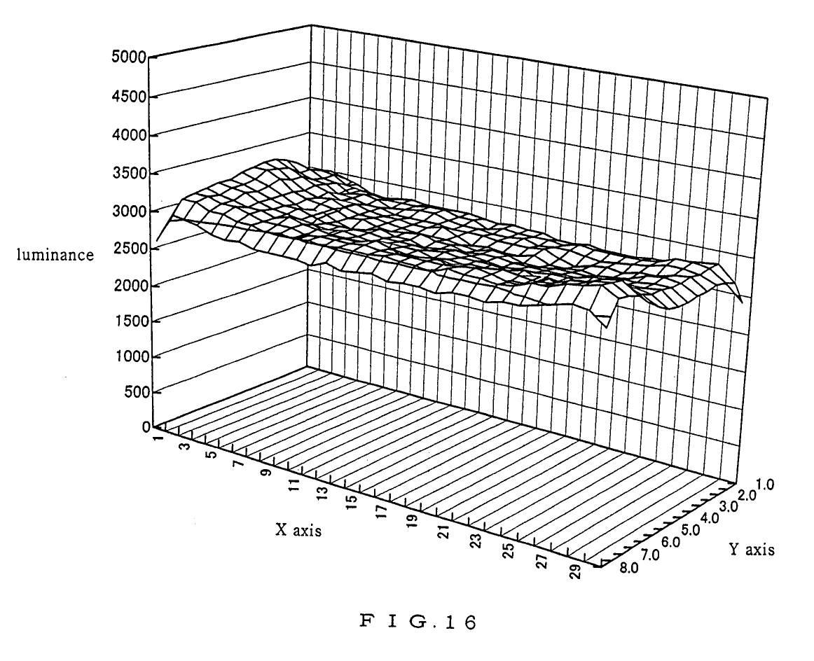

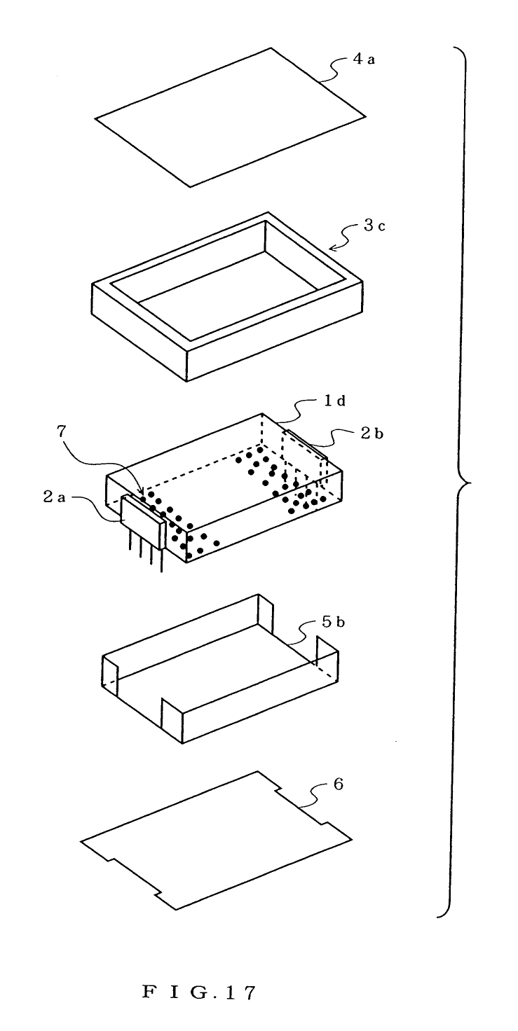

FIG. 16 is a diagram stereoscopically showing a luminance distribution when the case frame and the bottom plate are made of the white high-reflectance material without using the high-reflectance film. The average of the measured luminance is 2,933 cd/M².

As compared with the case of using only the white high-reflectance material, in the case in which the high-reflectance is arranged on the rear surface and the side surface, the average luminance is increased to 3,875 cd/m² from 2,933 cd/m², as 1.32 multiplication. Then, the luminance is extremely improved. In the case in which the high-reflectance film is arranged only on the rear surface, the average luminance is 3,689 cd/m². Obviously, it is the most advantageous in the case of arranging the high-reflectance film on the rear surface.

Further, the uniformity of the luminance distribution on the light-emitting surface is not varied, irrespective of the arrangement of the high-reflectance film. Obviously, a scattering effect on portions other than the light-guide plate is not necessarily important for the uniformity of the luminance on the light-emitting surface.

The reflecting plate having the high reflectance is sandwiched between the light-guide plate and the case frame in the second embodiment. However, advantageously, the surface is processed so that the inner surface of the case frame surrounding the light-guide plate has a high reflectance, for example, the surface is buffed or the high-reflectance film is adhered to the inner surface of the case frame. Further, advantageously, the reflecting plate is arranged only on the rear surface of the light-guide plate.

The reflecting plate is arranged at the light-guide portion (on the rear surface and the side surface) of the light-guide plate. However, obviously, light which is outputted to the outside is re-inputted to the light-guide plate, is effectively used, and the luminance is increased by providing the reflecting plate on both opposed surfaces, though this phenomenon is different because most light which has reached to the opposed surfaces of the mounted surface of the LED module, directly passes through the outside of the light-guide plate (airspace). Because the light outputted from the LED module has a strong directivity, most light is inputted to both opposed surface of the mounted surface of the LED module, directly or indirectly through the total reflection, at an almost right angle.

In this case, obviously, the leaked light of 90% or more is used again, by using any of the method for arranging the reflecting plate to the light-guide plate via the airspace and the method for directly adhering the reflecting plate to the light-guide plate not via the airspace. Hence, the present invention includes a modification in which the reflecting plate is arranged at portions other than the LED module on the opposed surfaces of the mounted surface of the LED module. FIG. 17 is an exploded perspective view of the area light source apparatus when the reflecting plate 5b is arranged on the rear surface of the light-guide plate and on the side surface other than the LED module portion.

The LED module is arranged on the two opposed side-surfaces of the light-guide plate in the second embodiment. However, since the light scatterer pattern realizes almost uniform luminance-distribution, the LED module may be arranged only on one side surface of the light-guide plate or on three side surfaces or at four side surfaces. Further, the mounted portion of the LED module is not limited to the center on the side surface and may be any portion if it is on a peripheral side-surface of the light-guide plate. In other words, according to the present invention, at least one LED module is arranged on the peripheral side-surface of the light-guide plate.

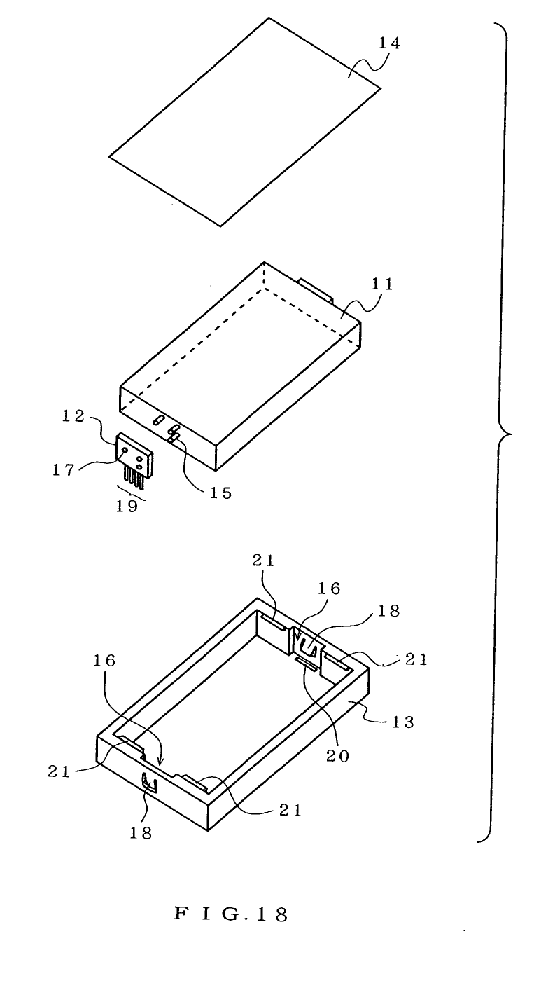

Next, a third embodiment of the present invention will be described. FIG. 18 is an exploded perspective view of a area light source apparatus according to the third embodiment of the present invention.

Referring to FIG. 18, the area light source apparatus comprises a transparent light-guide plate 11 which is planar- and rectangular-shaped, an LED module 12 as a light source, a case frame 13 which is formed integrally with a bottom plate, and a light scattering sheet 14 arranged on an upper surface of the light-guide plate 11.

Three pins 15 for positioning the LED module 12 are provided on opposed side-surfaces in a direction perpendicular to a longitudinal direction of the light-guide plate 11. The pins 15 are formed integrally with the light-guide plate 11 or separately therefrom. A light scatterer pattern is formed on a rear surface of the light-guide plate 11 to scatter light inputted to the light-guide plate 11 from the LED module 12. The light scatterer patterns are formed by the screen printing method using light reflecting white ink with a specific pattern. The light-guide plate 11 uses transparent materials such as an acrylic material and glass.

The LED module 12 comprises red (R), green (G), and blue (B) LED chips. Holes 17, into which the pins 15 are fitted, are formed to the LED module 12. The LED module 12 is mounted on the light-guide plate 11 without using an adhesive and are positioned, by fitting the pins 15 into the holes 17.

The case frame 13 is formed integrally with a bottom plate. The case frame 13 is made of, for example, a resin material. A concave portion 16 for accommodating the LED module 12 is formed at opposed inner-surfaces in a direction perpendicular to a longitudinal direction of the case frame 13. A spring 18 with a plate spring structure, for pressing the LED module 12 to the light-guide plate 11 is formed on the inner surface of the case frame 13 on which the concave portion 16 is formed. The spring 18 is formed integrally with the case frame 13. The spring 18 may not be used when the LED module 12 is mounted on the light-guide plate 11 by the three pins 15 and is positioned.

A hole 20 for pulling out a lead, that is, a lead 19 of the LED module 12, is provided at a bottom plate of the case frame 13 which is exposed by forming the concave portion 16.

In addition, a hook 21, as a projected latching portion, is provided at an upper portion of an inner surface of the concave portion 16.

Upon assembling, first, the pins 15 formed on the light-guide plate 11 are pierced into the holes 17 formed on the LED module 12, thereby attaching and positioning the LED module 12 to the light-guide plate 11.

Next, the light-guide plate 11 is fitted into the case frame 13 formed integrally with the bottom plate in a descending direction, and is fixed by the hook 21 provided at the upper portion of the inner surface of the case frame 13. In this case, the LED module 12 is pressed to the light-guide plate 11 by the spring 18 provided for the case frame 13 and is fixed to the light-guide plate 11. Finally, the light scattering sheet 14 is adhered onto an outer end surface of the case frame 13 in a descending direction.

Next, the method for positioning the LED module upon mounting the LED module on the light-guide plate will be described.

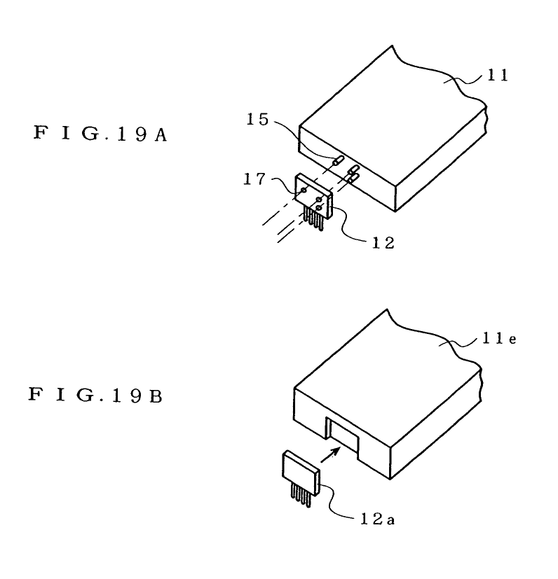

FIGS. 19A and 19B are perspective views showing examples of the method for positioning the LED module.

FIG. 19A shows a method for positioning the LED module by using the pin, that is, the method shown in FIG. 18 according to the third embodiment.

Referring to FIG. 19A, the three pins 15 are formed on a side surface in a direction perpendicular to a longitudinal direction of the light-guide plate 11, integrally with the light-guide plate 11 or separately therefrom. The holes 17 are formed at positions corresponding to the pins 15 in the LED modules 12. The LED module 12 is positioned to the light-guide plate 11 by piercing the pins 15 into the holes 17.

The two pins 15 of the three ones are formed horizontally to an upper surface of the light-guide plate 11. The remaining one is formed, not linear-symmetrically to a center line of the side surface in a height direction. Because erroneous mounting of a rear side and a front side of the LED module 12 is prevented to correctly mount the LED module 12.

Incidentally, in this example, the number of pins is three and a concave portion (not shown) is provided on the case frame. However, the number of pins may be one because the LED module can be positioned without rotation thereof in the concave portion by providing a spring (not shown) for pressing the LED module to the concave portion.

FIG. 19B shows a method for positioning the LED module by providing a concave portion on a side surface in a direction perpendicular to a longitudinal direction of a light-guide plate 11e and by accommodating an LED module 12a in the concave portion. In this case, a spring (not shown) for pressing the LED module 12a to the light-guide plate 11e is formed on an inner surface of the case frame, and the LED module 12a is pressed to the light-guide plate 11e by using the spring, thus positioning the LED module 12a.

According to this method, a concave portion for accommodating the LED 12a may not be provided on the case frame. Since the pin is not used, the LED module 12a for general purpose may be used, thus requiring no specific LED module on which a hole is formed.

In the above-stated area light source apparatus, the light inputted to the light-guide plate from the LED module travels in the light-guide plate, is scattered by the light scatterer pattern, reaches the light scattering sheet adhered onto the upper surface of the light-guide plate, is scattered by the light scattering sheet, and is outputted with a uniform illumination distribution.

As mentioned above, the area light source apparatus has a structure capable of working from a single direction so that the light-guide plate is fitted into the case frame in the descending direction and the light scattering sheet is adhered onto the outer end surface of the case frame in the descending direction. Consequently, the reverse of a work (worked product) during working is unnecessary, the working is not troublesome, and the automation of the processes is simple.

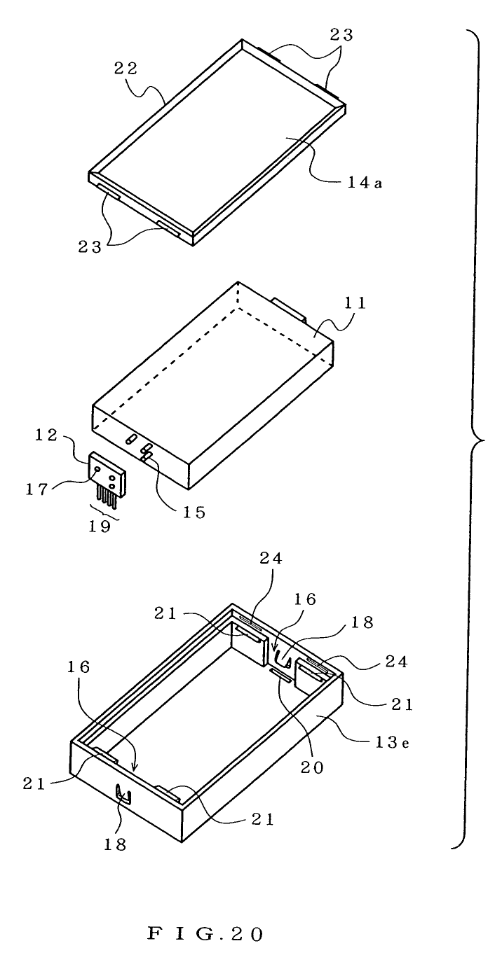

FIG. 20 is an exploded perspective view showing the area light source apparatus shown in FIG. 18 according to one modification of the third embodiment. Referring to FIG. 20, a light scattering sheet 14a is adhered onto a lower surface of a reinforcing frame 22 made of an acrylic material which is provided around the light scattering sheet 14a. A case frame 13e has a notch corresponding to a portion for accommodating the reinforcing frame 22 of the light scattering sheet 14a at a part of an upper end surface. A hook 23, as a projected latching portion, is provided on both end surfaces in a direction perpendicular to a longitudinal direction of the reinforcing frame 22. The hook 23 is fitted into a concave portion 24 provided on an inner surface of the notch of the case frame 13e, thereby accommodating the reinforcing frame 22 in the case frame 13e. Others are similar to the structure of the area light source apparatus shown in FIG. 18 and, therefore, a description thereof is omitted.

Then, the hook 23, as the projected latching portion, may be provided on both end surfaces of the reinforcing frame 22 in the longitudinal direction thereof.

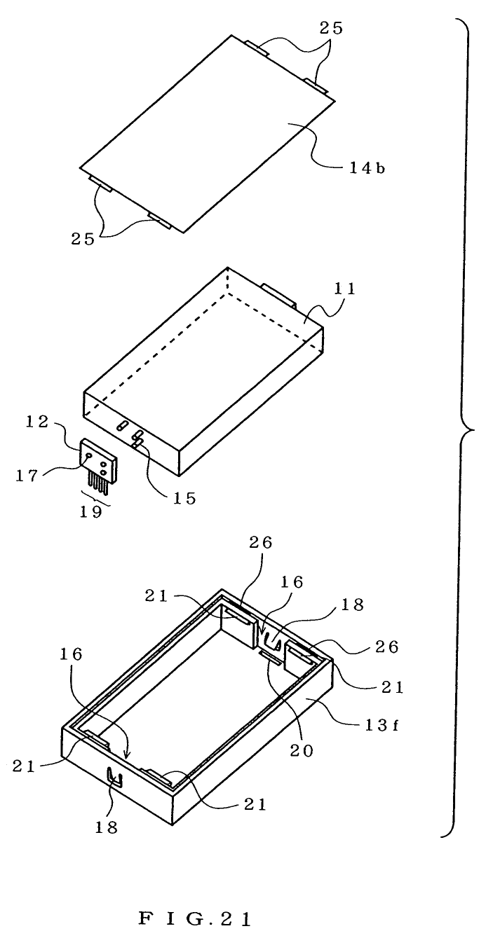

FIG. 21 is an exploded perspective view showing the area light source apparatus shown in FIG. 18 according to another modification of the third embodiment. Referring to FIG. 21, a case frame 13f has a notch corresponding to a portion for accommodating a light scattering sheet 14b made of an acrylic material at a part of an upper end surface of the case frame 13f. A hook 25, as a projected latching portion, is provided on both end surfaces in a direction perpendicular to a longitudinal direction of the light scattering sheet 14b. The hook 25 is fitted into a concave portion 26 provided on an inner surface of the notch of the case frame 13f, thereby accommodating the light scattering sheet 14b in the case frame 13f.

Then, the hook 25, as the projected latching portion, may be provided on both end surfaces of the light scattering sheet 14b in the longitudinal direction thereof.

The light scattering sheet 14b comes into contact with the light-guide plate 11 at a part of the acrylic surface which is made coarse by, e.g., sandblast. The acrylic surface functions as the light scattering sheet. Although a thickness of the light scattering sheet 14b is 0.5 mm at the part of the acrylic surface contacted with the light-guide plate 11, it is 1.0 mm, that is, thicker, so as to keep the strength thereof at a peripheral portion (including the hook 25), which comes into contact with the case frame 13f. Others are similar to the structure of the area light source apparatus shown in FIG. 18 and, therefore, a description thereof is omitted.

Since the light scattering sheet is adhered onto the outer-end surface of the case frame as shown in FIG. 18 in the third embodiment, working processes for positioning the light scattering sheet and for cutting it are required. However, the light scattering sheet is fitted into the case frame in the modifications shown in FIGS. 20 and 21 and, therefore, the above working processes can be omitted.

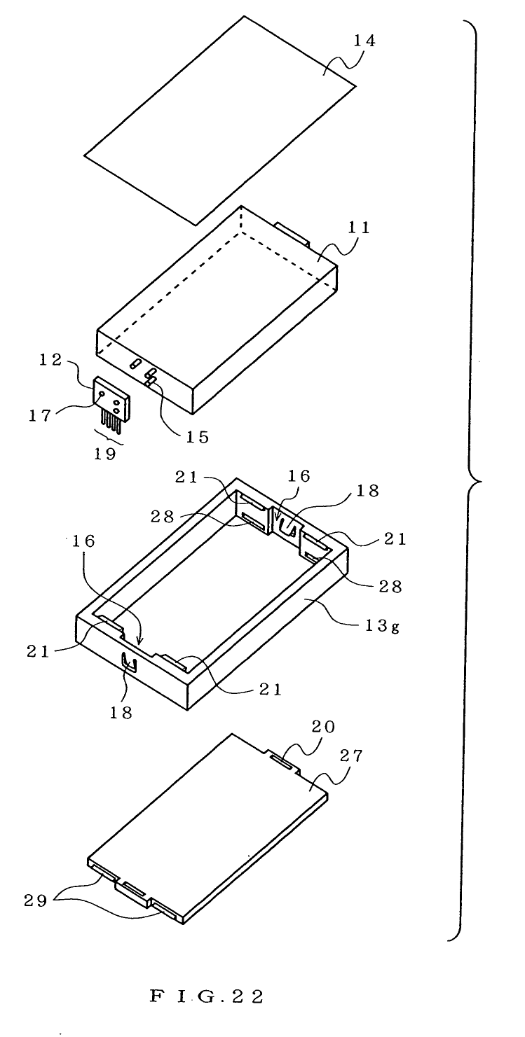

FIG. 22 is an exploded perspective view showing the area light source apparatus shown in FIG. 18 according to another modification of the third embodiment. Referring to FIG. 22, in the area light source apparatus, a case frame 13g is not formed integrally with a bottom plate but a bottom plate 27 is fitted into the case frame 13g.

Concave portions 28 are provided at a lower portion of the opposed inner surfaces in a direction perpendicular to a longitudinal direction of the case frame 13g. Hooks 29, as projected latching portions, are provided on both end surfaces in a direction perpendicular to a longitudinal direction of the bottom plate 27. The hooks 29 are fitted into the concave portions 28 provided on the inner surfaces of the case frame 13g, and the bottom plate 27 is fixed to the case frame 13g.

Incidentally, the concave portions 28 may be provided at a lower portion of the opposed inner surfaces in the longitudinal direction of the case frame 13g, and the hooks 29, as the projected latching portions, may be provided on both end surfaces of the bottom plate 27 in the longitudinal direction thereof. Others are similar to the area light source apparatus shown in FIG. 18 and, therefore, a description is omitted.

Although the two LED modules, as light sources, are used according to the third embodiment, the number of the LED modules may be one or be a plural to be arranged at all the inner surfaces because a luminance distribution can almost be uniform by the shape of the light scatterer pattern formed on the lower surface of the light-guide plate, in the present invention. The LED module is arranged at the center portion of the inner surface but is not limited to this, and may be arranged at any place of the inner surfaces. In other words, the present invention can be applied to a case of using at least one LED module.

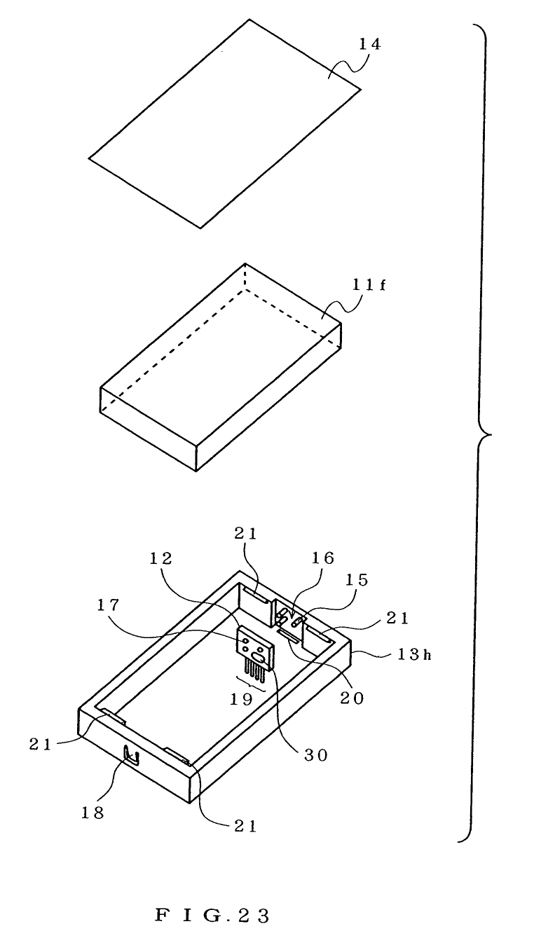

Next, a fourth embodiment of the present invention will be described. FIG. 23 is an exploded perspective view of a area light source apparatus according to a fourth embodiment of the present invention.

Referring to FIG. 23, the area light source apparatus comprises a transparent light-guide plate 11f which is planar- and rectangular-shaped, an LED module 12 as a light source, a case frame 13h which is formed integrally with a bottom plate, and a light scattering sheet 14 which is arranged on an upper sheet of the light-guide plate 11f.

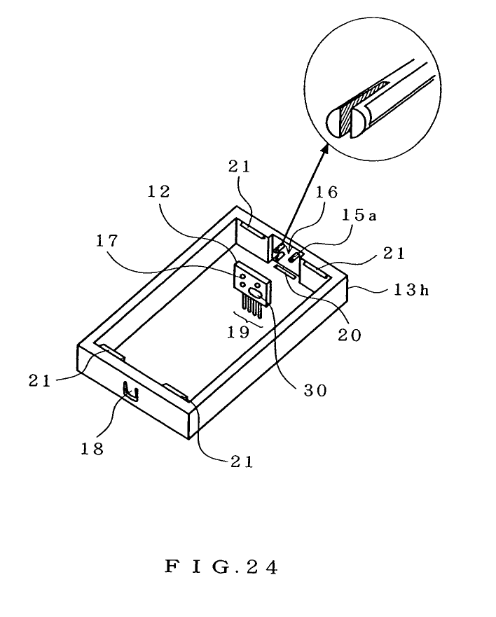

The case frame 13h is formed integrally with the bottom plate, and is made of a material with a high working precision and a high mechanical intensity, such as polycarbonate resin. Concave portion 16 for positioning the LED module 12 are formed on one of opposed inner surfaces in a direction perpendicular to a longitudinal one of the case frame 13h, and three pins 15 for positioning the LED module 12 are provided on inner surfaces of the concave portions 16. The pins 15 are formed integrally with the case frame 13h or separately therefrom. As shown in FIG. 24, instead of the pins 15, split pins 15 may be used. FIG. 24 is a perspective view of the case frame and an enlarged view of one split pin, in place of the pin shown in FIG. 23.

Two pins 15 of the three ones are formed horizontally to an upper surface of the case frame 13h. The remaining one is formed, not linear-symmetrically to a center line of the concave portion 16 in a height direction. Because erroneous mounting of a rear surface and a front side of the LED module 12 is prevent to correctly mount the LED module 12. Incidentally, in this example, the number of pins is three. However, the number of pins may be one or two because the LED module can be positioned without rotation thereof in the concave portion 16.

A hole 20 for pulling out a lead, that is, a lead 19 of the LED module 12, is provided on a bottom plate of the case frame 13h which is exposed by forming the concave portion 16.

A spring 18 with a plate spring structure is formed on opposed inner surfaces of the case frame 13h. The spring 18 is formed integrally with the case frame 13h.

The spring 18 presses the light-guide plate 11f to the LED module 12 side when the light-guide plate 11f is accommodated in the case frame 13h to prevent a space between the light-guide plate 11f and the LED module 12. The spring 18 for pressing a rear surface of the LED module 12 may be located near the pin on the LED module 12 side.

Further, hooks 21, as projected latching portions, are provided at both sides of the concave portion 16 and the spring 18 onto an upper portion of the inner surfaces of the case frame 13h.

The LED module 12 comprises red (R), green (G), and blue (B) LED chips. Holes 17, into which the pins 15 are fitted, are formed to the LED module 12. The LED module 12 is mounted on the case frame 13h without using an adhesive and are positioned, by fitting the pins 15 into the holes 17.

A light scatterer pattern for scattering light inputted to the light-guide plate 11f from a light-emitting window 30 of the LED module 12 is formed on a lower surface of the light-guide plate 11f. The light scatterer patterns are formed by the screen printing method using light reflecting white ink with a specific pattern. The light-guide plate 11f is made of a transparent material such as an acrylic material or glass.

Upon assembling, first, the pins 15 for positioning the LED module 12 are pierced into the holes 17 formed on the LED module 12, thereby mounting and positioning the LED module 12 to the case frame 13h.

Next, the light-guide plate 11f is fitted into the case frame 13h formed integrally with the bottom plate in a descending direction, and is fixed by the hook 21 provided at the upper portion of the inner surface of the case frame 13h. In this case, the light-guide plate 11f is pressed to the LED module 12 side by power of the spring 18 provided for the case frame 13h. Further, the LED module 12 is pressed to the case frame 13h by the above generated power. Finally, the light scattering sheet 14 is adhered onto an outer end surface of the case frame 13h in the descending direction.

In the above-stated area light source apparatus, the light inputted to the light-guide plate 11f from the light-emitting window 30 of the LED module 12 travels in the light-guide plate 11f, is scattered by the light scatterer pattern, reaches the light scattering sheet 14 adhered onto the upper surface of the light-guide plate 11f, is scattered by the light scattering sheet 14, and is outputted with a uniform illumination distribution.

The above fourth embodiment employs a single LED module as the light source. In the case of using two LED modules, as shown in FIG. 25, concave portions 16 for accommodating the two LED modules 12 are formed on both opposed inner surfaces in a direction perpendicular to a longitudinal direction of a case frame 13i, pins 15b for positioning the LED modules 12 are formed on inner surfaces of the concave portion 16, and the pins 15b are pieced into the holes 17 of the LED module, thus arranging the LED module 12.

Upon assembling, first, the pins 15b for positioning the LED module 12 are pierced into the holes 17 formed on the LED module 12, thereby mounting the LED module 12 on the case frame 13i. In this state, the LED module 12 is temporarily fixed.

Next, the light-guide plate 11f is fitted into the case frame 13i in a descending direction while preventing the reversal of the LED module 12. Preferably, as shown in FIG. 25, the pins 15b use split pins and are thicker at ends thereof upon temporarily fixing and assembling the LED module 12. When the light-guide plate 11f is pressed into the case frame 13i, the LED module 12 is completely fixed to the case frame 13i.

Referring back to FIG. 23, although only the single spring 18 is provided, a method for providing a plurality of springs is effective because the LED module 12 is further completely fixed to the case frame 13i.

Although the spring is not provided in FIG. 25, advantageously, the LED module is further completely fixed to the case frame by employing a method for providing at least one spring at a portion where no LED module exists.

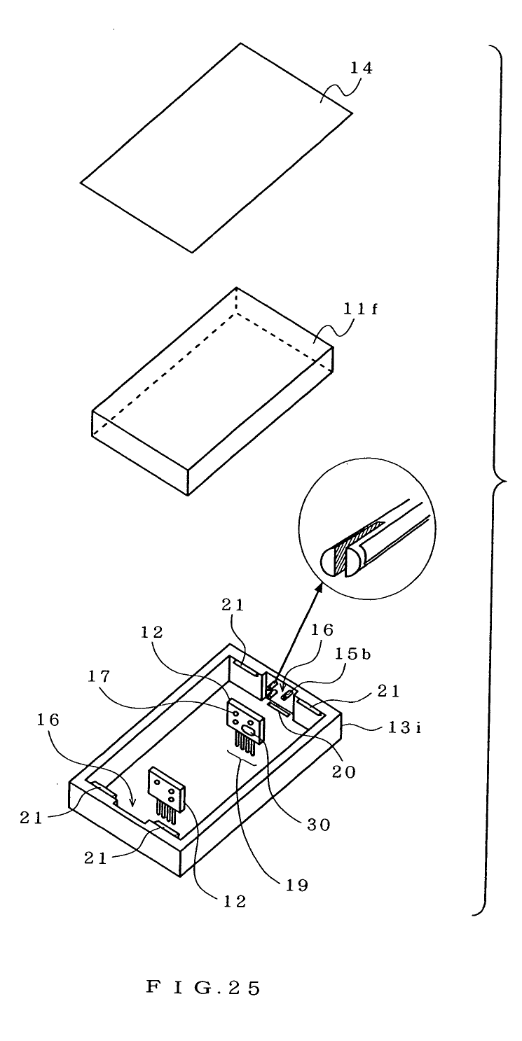

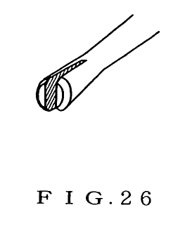

Furthermore, preferably, the split pins 15a and 15b shown in FIGS. 24 and 25 are thicker at first ends thereof, thinner near the center, and thicker at second ends thereof, as shown in FIG. 26. The LED module is to be pressed and be returned in the first-ends direction because the second ends of the split pins 15a and 15b are thick. However, the LED module is more completely fixed by reducing the space between the light-guide plate and the LED module, with the spring on the opposite side in the case of one LED module, or with the split pins on the both sides in the case of two LED modules.

The concave portions 16 for accommodating the LED module 12 are formed on the inner surfaces of the case frame and the pins 15 for positioning the LED module 12 are formed on the inner surfaces of the concave portions 16 according to the fourth embodiment. However, when concave portions for accommodating the LED module 12 are formed on side surfaces in a direction perpendicular to a longitudinal direction of the light-guide plate, the pins 15 may be formed at the inner surfaces of the case frame without forming the concave portions to the case frame.

As described above, the area light source apparatus has a structure capable of working from a single direction so that the light-guide plate is fitted into the case frame in the descending direction and the light scattering sheet is adhered onto the outer end surface of the case frame in the descending direction. Consequently, the reverse of a work (worked product) during working is unnecessary, the working is not troublesome, and the automation of the processes is simple.

FIG. 27 is an exploded perspective view showing the area light source apparatus shown in FIG. 23 according to one modification of the fourth embodiment. Referring to FIG. 27, a light scattering sheet 14a is adhered onto a lower surface of a reinforcing frame 22 made of an acrylic material, which is provided around the light scattering sheet 14a. A case frame 13j has a notch corresponding to a portion for accommodating the reinforcing frame 22 of the light scattering sheet 14a at a part of an upper end surface. Hook 23, as projected latching portions, are provided on both end surfaces in a direction perpendicular to a longitudinal direction of the reinforcing frame 22. The hooks 23 are fitted into concave portions 24 provided on an inner surface of the notch of the case frame 13j, thereby accommodating the reinforcing frame 22 in the case frame 13j. Others are similar to the structure of the area light source apparatus shown in FIG. 23 and, therefore, a description thereof is omitted.

Then, the hooks 23, as the projected latching portions, may be provided on both end surfaces of the reinforcing frame 22 in the longitudinal direction thereof.

FIG. 28 is an exploded perspective view showing the area light source apparatus shown in FIG. 23 according to another modification of the fourth embodiment. Referring to FIG. 28, a case frame 13k has a notch corresponding to a portion for accommodating a light scattering sheet 14b made of an acrylic material at a part of an upper end surface thereof. Hooks 25, as projected latching portions, are provided on both end surfaces in a direction perpendicular to a longitudinal direction of the light scattering sheet 14b. The hooks 25 are fitted into concave portions 26 provided on an inner surface of the notch of the case frame 13k, thereby accommodating the light scattering sheet 14b in the case frame 13k.

Then, the hooks 25, as the projected latching portions, may be provided at both end surfaces of the light scattering sheet 14b in the longitudinal direction thereof.

The acrylic surface at an area where the light scattering sheet 14b comes into contact with the light-guide plate 11f is made coarse by, for example, sandblast, and functions as a light scattering sheet. Although a thickness of the light scattering sheet 14b is 0.5 mm at the part of the acrylic surface contacted with the light-guide plate 11f, it is 1.0 mm, that is, thicker, at a peripheral portion (including the hooks), which comes into contact with the case frame 13k. Others are similar to the structure of the area light source apparatus shown in FIG. 23 and, therefore, a description thereof is omitted.

Since the light scattering sheet is adhered onto the outer-end surface of the case frame in the area light source apparatus shown in FIG. 23 according to the fourth embodiment, working processes for positioning of the light scattering sheet and for cutting it are required. However, the light scattering sheet is fitted into the case frame in the area light source apparatus in FIGS. 27 and 28 and, therefore, the above working processes can be omitted.

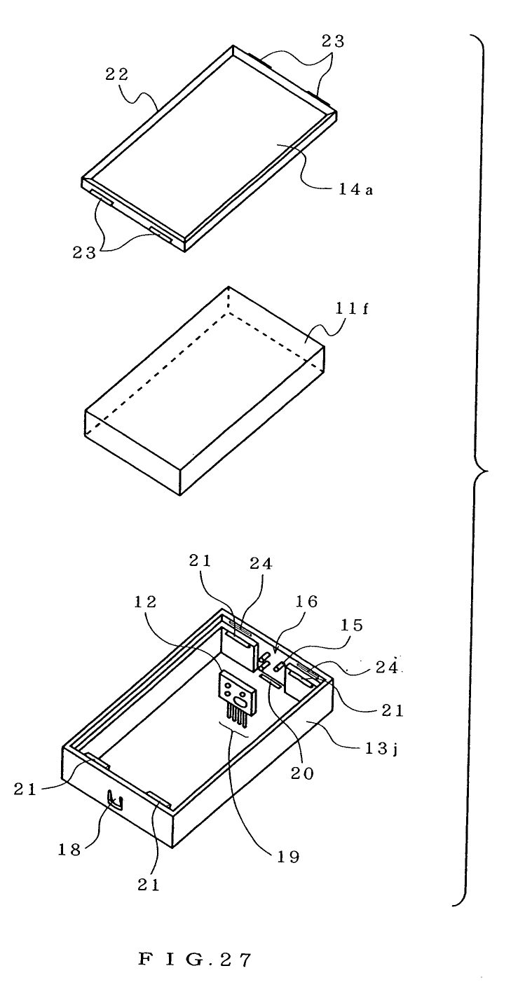

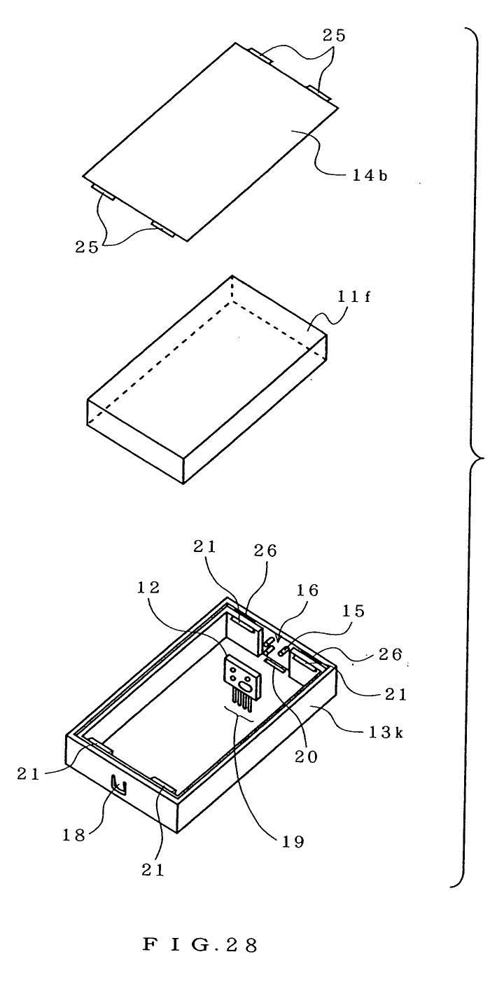

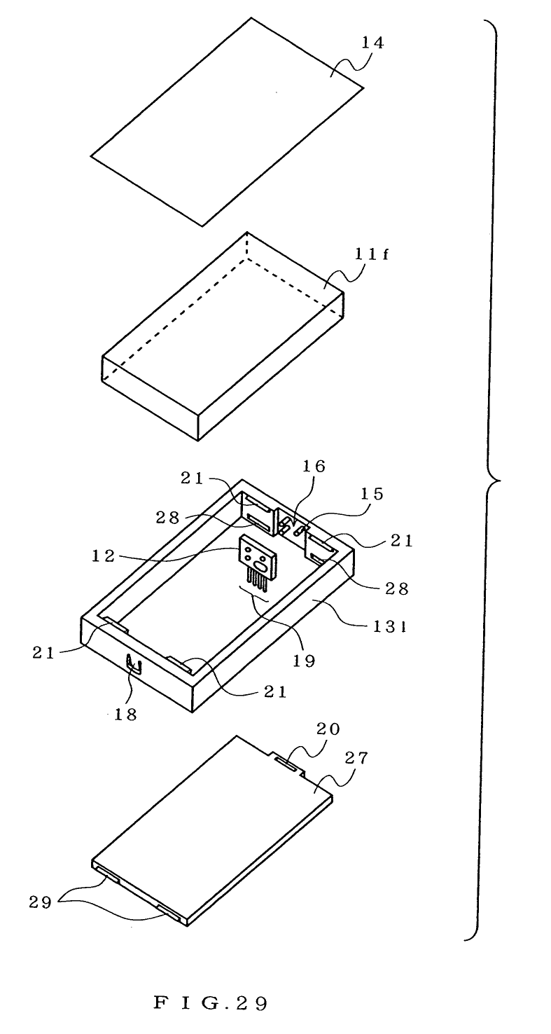

FIG. 29 is an exploded perspective view showing the area light source apparatus shown in FIG. 23 according to another modification of the fourth embodiment. Referring to FIG. 29, the area light source apparatus is structured by fitting a bottom plate 27 into a case frame 131 without forming the case frame 131 integrally with the bottom plate 27.

Concave portions 28 are provided at a lower portion of opposed inner surfaces in a direction perpendicular to a longitudinal direction of the case frame 131. Hooks 29, as projected latching portions, are provided on both end surfaces in a direction perpendicular to a longitudinal direction of the bottom plate 27. The hooks 29 are fitted into the concave portions 28 provided on the inner surfaces of the case frame 131, and the bottom plate 27 is fixed to the case frame 131.

Incidentally, the concave portions 28 may be provided at a lower portion on the opposed inner surfaces in the longitudinal direction of the case frame 131, and the hooks 29, as the projected latching portions, may be provided at both end portions of the bottom plate 27 in the longitudinal direction thereof. Others are similar to the area light source apparatus shown in FIG. 23 and, therefore, a description is omitted.

Although the number of LED modules, as the light sources, is one or two in the above modifications, in the present invention, it is not limited to one or two LED modules and the LED module may be arranged at all the side surfaces because a luminance distribution can almost be uniform by the shape of the light scatterer pattern formed on the lower surface of the light-guide plate. The LED module may be arranged in the center of the side surface of the light-guide plate but is not limited to this, and may be arranged at any place of the side surfaces. In other words, the present invention can be applied to a case of using at least one LED module.

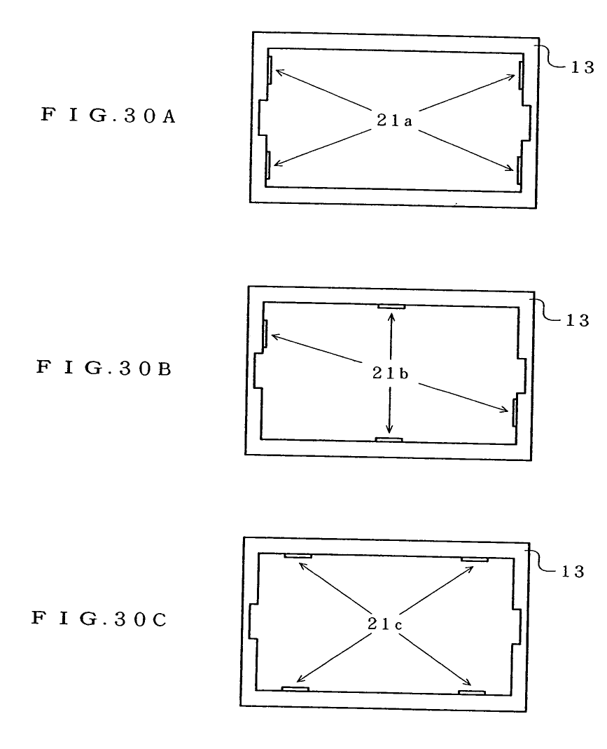

Next, according to the third and fourth embodiments, a position of the hook for fixing the light-guide plate to the case frame will be described. FIGS. 30A to 30C are plan views of the case frame showing examples of a formed position of the hook in a plane direction.

Referring to FIG. 30A, four hooks 21a are formed on opposed inner surfaces in a direction perpendicular to a longitudinal direction of the case frame 13. Hooks 21a are formed on both sides of the mounted position of the LED module.

Referring to FIG. 30B, four hooks 21b are formed on opposed inner surfaces in a direction perpendicular to a longitudinal direction of the case frame 13 and on opposed inner surfaces in a longitudinal direction of the case frame 13. The hooks 21b formed on the opposed inner surfaces in a direction perpendicular to a longitudinal direction of the case frame 13, are point-symmetrical to the center of the case frame 13, and the hooks 21b formed on the inner surfaces in a longitudinal direction of the case frame 13 are positioned in the center of the inner surfaces in the longitudinal direction.

Further, referring to FIG. 30C, four hooks 21c are formed while they are mutually separated on the opposed inner surfaces of the case frame 13 in the longitudinal direction thereof.

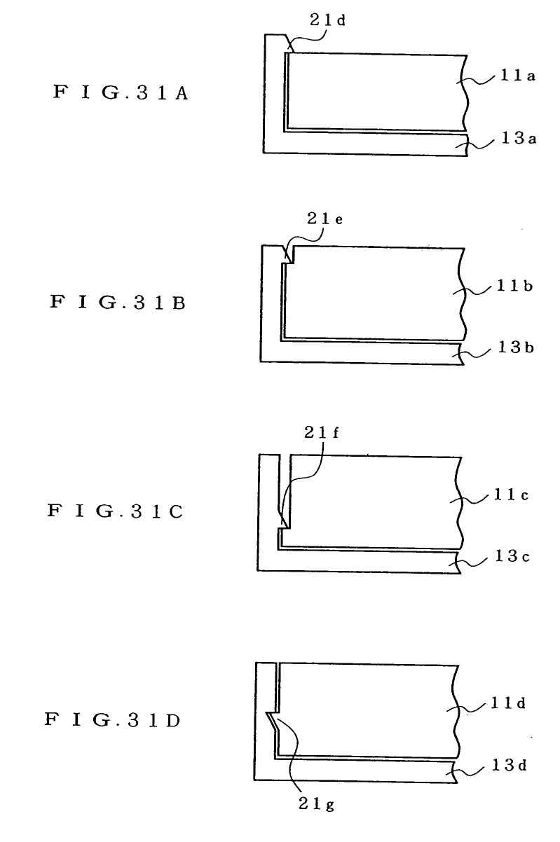

FIGS. 31A to 31D are partially cross-sectional views showing examples of the formed position of the hook in a height direction.

Referring to FIG. 31A, hooks 21d as projected latching portions, having engaged surfaces at lower ends, are provided at a top portion of the inner surfaces of a case frame 13a where the height of the light-guide plate 11a is up to the engaged surfaces of the hooks 21d, and the light-guide plate 11a is fixed to the case frame 13a by being engaged to the engaged surface in an ascending direction.

Referring to FIG. 31B, hooks 21e are provided at a top portion of the inner surface of a case frame 13b, and a light-guide plate 11b is formed with a stepped surface which is engaged to an engaged surface of the hook 21e in an ascending direction. An upper surface of the light-guide plate 11b and an outer end surface of the case frame 13b exist on the same plane.

Referring to FIG. 31C, hooks 21f are provided at an intermediate portion of an inner surface of a case frame 13c in a height direction thereof, and a light-guide plate 11c is formed with a stepped surface which is engaged to an engaged surface of the hook 21f in an ascending direction. An upper surface of the light-guide plate 11c and an outer end surface of the case frame 13c exist on the same plane.

Further, referring to FIG. 31D, hooks 21g are provided at an intermediate portion of a light-guide plate 11d in a height direction, and concave portions, into which the hooks 21g are fitted, are provided at an intermediate portion of a case frame 13d in a height direction thereof.

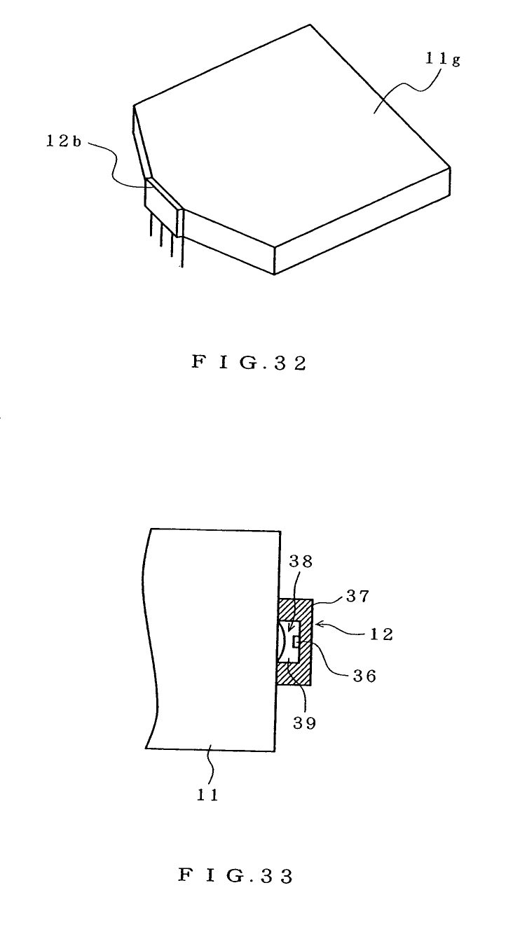

Incidentally, although the rectangular light-guide plate is used in the modifications of the fourth embodiment, effectively, the light-guide plate has a polygon or a curve. FIG. 32 is a diagram showing one example of a light-guide-plate shape. Referring to FIG. 32, an LED module 12b is arranged on a side surface of a light-guide plate of 11g, having a polygon.

FIG. 33 is a cross-sectional view when the LED module makes contact with the light-guide plate. Referring to FIG. 33, an LED chip 36 is protected by transparent resin 39 which is formed to be accommodated in a concave portion 38 provided at a printing board 37. Then, since the LED module 12 is made contact with the light-guide plate 11, the leak of light outputted from the LED chip 36, to the outside can be prevented. When the transparent resin 39 is provided to be protruded beyond the concave portion 38 provided for the printing board 37, the LED module 12 is not made contact with the light-guide plate 11 and it is unpreferable that light from the LED chip 36 is leaked from a space between the LED module 12 and the light-guide plate 11.

The screen printing method is used as the method for forming the light scatterer patterns in the first to fourth embodiments. However, a variety of organic or inorganic light scattering materials (mainly, white paint) may be applied to the rear surface of the light-guide plate by an offset printing method, an ink-jet printing method, etc. to form the light scatterer patterns.

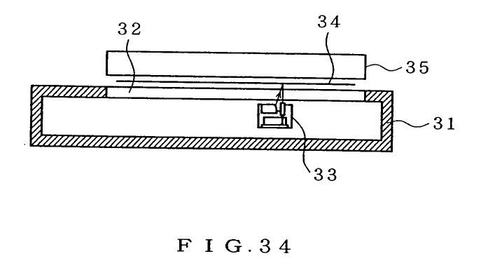

Next, an image reading apparatus using the area light source apparatus of the present invention will be described. FIG. 34 is a diagram showing one example of a CIS-type image reading apparatus capable of reading a transparent original. The area light source apparatus of the present invention is used as a light source for illuminating the transparent original.

Referring to FIG. 34, the image reading apparatus comprises a case main body 31 whose upper surface has an original base glass 32 and a contact image sensor unit 33 in the case main body 31. A sheet original or a transparent original 34 is placed on the original base glass 32. The contact image sensor unit 33 includes a line light source necessary for reading the sheet original which is lit off when the transparent original 34 is read.

A area light source apparatus 35 of the present invention is provided upstream of the original base glass 32, and is incorporated in an original cover (not shown) or is replaced with the original cover upon reading the transparent original 34.

The contact image sensor unit 33 is reciprocatedly driven in a predetermined direction, light outputted from the area light source apparatus 35 is transmitted through the original base glass 32, and the light is detected by a line sensor via a rod lens array in the contact image sensor unit 33, thus to read and scan the transparent original 34.

Although the CIS-type image reading apparatus has been described with reference to FIG. 34, obviously, the present invention is not limited to the CIS-type image reading apparatus and can be applied to a CCD-type image reading apparatus using another reduction-type optical system.

What is claimed:

1. An area light source apparatus comprising: a light-guide plate which is planar-shaped; at least one light source which is arranged on a peripheral side-surface of said light-guide plate; a case frame formed integrally with a bottom cover, for accommodating said light-guide plate and said light source; and a light scattering sheet which is arranged on an upper surface of said light-guide plate, wherein said light-guide plate is fitted into said case frame and is fixed to said case frame by a hook, as a projected latching portion, having an engaged surface on a lower end, which is provided for said case frame or said light-guide plate.

2. An area light source apparatus comprising: a light-guide plate which is planar-shaped; at least one light source which is arranged on a peripheral side-surface of said light-guide plate; a case frame formed integrally with a bottom cover, for accommodating said light-guide plate and said light source; and a light scattering sheet which is arranged on an upper surface of said light-guide plate, wherein said light scattering sheet is adhered to a lower surface of a reinforcing frame,
said case frame has a notch corresponding to a portion for accommodating said reinforcing frame at a part of an upper end surface, and
said reinforcing frame is accommodated in said case frame by fitting a projected latching portion provided at an end surface of said reinforcing frame, into a concave portion provided on an inner surface of the notch of said case frame.

3. An area light source apparatus comprising: a light-guide plate which is planar-shaped; at least one light source which is arranged on a peripheral side-surface of said light-guide plate; a case frame formed integrally with a bottom cover, for accommodating said light-guide plate and said light source; and a light scattering sheet which is arranged on an upper surface of said light-guide plate, wherein said case frame has a notch corresponding to a portion for accommodating said light scattering sheet at a part of an upper end surface, and said light scattering sheet is accommodated in said case frame by fitting a projected latching portion provided on an end surface of said light scattering sheet, into a concave portion provided on an inner surface of the notch of said case frame.

4. An area light source apparatus comprising: a light-guide plate which is planar-shaped; at least one light source which is arranged on a peripheral side-surface of said light-guide plate; a case frame for accommodating said light-guide plate and said light source; a bottom cover; and a light scattering sheet arranged at an upper surface of said light-guide plate,
wherein said bottom cover is fixed to said case frame by fitting a projected latching portion provided on an end surface of said bottom cover, into a concave portion provided at a lower portion of an inner surface of said case frame.

5. An area light source apparatus comprising: a light-guide plate which is planar-shaped; at least one light source which is arranged on a peripheral side-surface of said light-guide plate; a case frame formed integrally with a bottom cover, for accommodating said light-guide plate and said light source; and a light scattering sheet which is arranged on an upper surface of said light-guide plate,
wherein said light source is accommodated in a concave portion provided for said light-guide plate, and
said light-guide plate is fitted into said case frame and is fixed to said case frame by a hook, as a projected latching portion, having an engaged surface on a lower end, which is provided for said case frame or said light-guide plate while a spring provided for said case frame enables said light source to press said light-guide plate.

6. An area light source apparatus comprising: a light-guide plate which is planer-shaped; at least one light source which is arrange on a peripheral side-surface of said light-guide plate; a case frame formed integrally with a bottom cover, for accommodating said light-guide plate and said light source; and a light scattering sheet which is arranged on an upper surface of said light-guide plate,
wherein said light source is mounted on said case frame by fitting at least one pin formed on said case frame, into a hole formed on said light source corresponding to said pin, and
said light-guide plate is fitted into said case frame so that said light source is arranged on the peripheral side-surface of said light-guide plate.

7. An area light source apparatus according to claim 6, wherein said light-guide plate is fixed to said case frame by a hook, as a projected latching portion, which has an engaged surface at a lower end and is provided for said case frame or said light-guide plate.

8. An area light source apparatus according to any one of claims 1, 5, and 7, wherein said hooks are formed at an uppermost portion of the inner surfaces of said case frame, said light-guide plate is formed with a stepped surface for being engaged to the engaged surfaces of said hook in an ascending direction and, thus, the upper surface of said light-guide plate and an outer end surface of said case frame exist on the same plane.

9. An area light source apparatus according to any one of claims 1, 5, and 7, wherein said hooks are formed at an intermediate portion in a height direction of the inner surface of said case frame, said light-guide plate is formed with a stepped surface for being engaged to the engaged surface of said hook in an ascending direction and, thus, the upper surface of said light-guide plate and an outer end surface of said case frame exist on the same plane.

10. An image reading apparatus using a area light source apparatus according to any one of claims 4, 5, and 7, as an illumination light source of a transparent original.
